(19) United States
(12) Patent Application Publication
(10) Pub. No.: US 2005/0138034 A1
(43) Pub. Date: Jun. 23, 2005

(54) System and method for sharing resource properties in a multi-user environment

(75) Inventor: Mazen Faraj, Toronto (CA)

Correspondence Address: Gregory M. Doudnikoff;International Business Machines, Intellectual Property Law,T81/Bldg. 503, PO Box 12195, Research Triangle Park, NC, 27709, US

(73) Assignee: International Business Machines Corporation, Armonk, NY (US)

(21) Appl. No.: 10/829,579

(22) Filed: Apr. 22, 2004

(30) Foreign Application Priority Data
Dec. 17, 2003 (CA) 2,453,610

(51) Int. Cl. G06F 17/30

(52) U.S. Cl. 707/10

(57) ABSTRACT

A technique for use in a team sharing environment is provided. The technique is for persisting resource properties in an integrated development environment during transitions of data between a user and a team repository. The technique stores a list of property keys to be persisted and their associated resource property values in a property file. An associated property file is created for each resource having properties to be persisted. The property file may be used for storing a cache of prior resource property values. The property file is searchable for returning a list of the property keys and their associated resource property values. The property key name is qualified by appending the property key name to the name of the contributing resource. The property file is a metadata file. The metadata file is an XML file. An extension point may be employed for providing an application program interface to third party plug-ins for creating a property file for the third party plug-in.

### BACKGROUND OF THE INVENTION

1. Field of the Invention

The present invention relates generally to Integrated Development Environments (IDEs) and specifically to IDEs for use in a team environment.

2. Description of the Related Art

An Integrated Development Environment (IDE) is a programming environment that has been packaged as an application program. IDEs typically consisting of a code editor, a compiler, a debugger, and a graphical user interface (GUI). IDEs provide a user-friendly framework for many modern programming languages, such as Visual Basic, Java, and PowerBuilder and, thus, provide valuable tools that increase the productivity of developers. There are numerous IDEs available, and their users typically select one to use in accordance with a variety of factors.

One major factor in selecting an IDE is its extensibility. That is, how well third party software vendors can incorporate their own functionality into the IDE. This new functionality must seamlessly integrate into the IDE and the user need not be concerned with the manner in which the functionality was contributed. Extensibility of an IDE is an important factor since it gives the user the ability to enhance the functionality of the IDE if that functionality is missing. The user can either develop a plug-in or install a third party plug-in, if one is available, to perform the desired functionality.

The extensibility of the IDE is measured by the flexibility of Application Program Interfaces (APIs) that are available to code the extra functionality against. That is, how well is the design of the IDE exposed to third party software vendors that want to plug-in their own functionality into the IDE. A typical functionality of APIs is the ability to associate properties with resources, regardless of whether the resources are files or folders.

When Independent Software Vendors (ISVs) are writing plug-ins, they often need to associate properties with specific resources to aid in the functionality of their tools. For example, the Eclipse platform is an open source Java IDE that was designed with extensibility as one of its major goals. It allows ISVs to plug their functionality into virtually any portion of the base IDE. A portion of an Operating System (OS) file tree that represents a workspace of the user is modeled by Eclipse APIs as instances of an IResource class. As an ISV, developers can programmatically associate properties with this class, hence tagging properties to files and folders of the file system. These properties are very useful in supporting the functionality that is contributed by the ISV plug-in. In the Eclipse platform, team support uses persistent properties on projects to determine with which team vendor the user chooses to associate the project. The various menus contributed to the Eclipse project Team menu are controlled by that persistent property associated with the project specifying the team vendor.

However, although properties can be tagged to resources by ISVs these properties cannot be shared through team development. Often team sharing is a functionality that is overlooked when designing some aspects of IDE APIs. For example, in the case of the Eclipse Platform, even though the APIs provide the ability to set persistent properties on resources, once that resource is deleted from the user's workspace, these properties are deleted with the resource. Thus, tools that set properties on resources cannot expect their properties to survive a transfer to a team server and back when team development is being used in the IDE. That is, if the user deletes a project or resources from the Eclipse IDE, and re-adds them from a team repository, the IDE tools can not expect that the previously set properties will still be associated with the corresponding resources.

Therefore, there is a need for an IDE suitable for use in a team sharing environment.

### SUMMARY OF THE INVENTION

In accordance with an aspect of the present invention there is provided in a team sharing environment, an integrated development environment for persisting resource properties during transitions of data between a user and a team repository. The integrated development environment includes property file for storing property keys and their associated resource property values.

In accordance with a further aspect of the present invention there is provided for a team sharing environment, a method for persisting resource properties in an integrated development environment during transitions of data between a user and a team repository, the method including the step of storing, in a property file, a list of property keys to be persisted and their associated resource property values.

In yet a further aspect of the present invention, there is provided a computer program product having a computer readable medium tangibly embodying computer executable code for directing an integrated development environment to persist resource properties in a team sharing environment during transitions of data between a user and a team repository. The computer program product comprises code for storing, in a property file, a list of property keys to be persisted and their associated resource property values.

### BRIEF DESCRIPTION OF THE DRAWINGS

Embodiments of the invention will now be described by way of example only with reference to the following drawings in which:

FIG. 1 is a block diagram of a team development environment for an IDE;

FIG. 2 is an example of an XML specification for an extension point;

FIG. 3 is an example of an extension point definition;

FIG. 4 is an example of the contents of a property file; and

FIG. 5 is a schematic diagram illustrating a working directory structure.

Similar references are used in different figures to denote similar components.

### DESCRIPTION OF THE PREFERRED EMBODIMENTS

The following detailed description of the embodiments of the present invention does not limit the implementation of the invention to any particular computer programming language. The present invention may be implemented in any computer programming language provided that the Operating System (OS) provides the facilities that may support the requirements of the present invention. One embodiment is implemented in the Java computer programming language (or other computer programming languages in conjunction with Java). Any limitations presented would be a result of a particular type of operating system or computer programming language and would not be a limitation of the present invention.

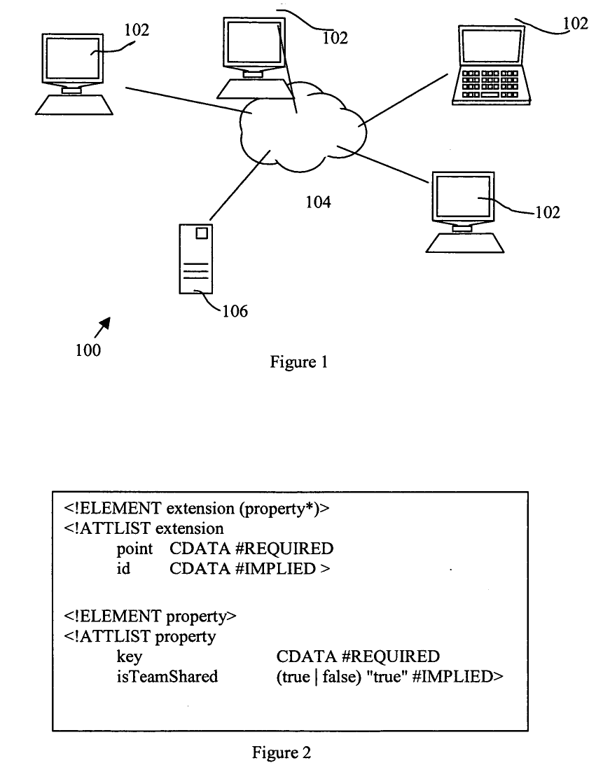

Referring to FIG. 1, a team development environment for a plurality of IDE users is shown generally by numeral 100. The environment 100 comprises a plurality of workstations 102, a network 104, and a team sever 106. The team server 106 comprises Software Configuration Management (SCM) repository, which is a persistent store for coordinating multi-user access to projects and team streams. CVS was the default SCM tool integrated with the IDE and it was used to test the implementation. The team server 106 further includes a file system for storing resources and projects. Each of the workstations 102 includes an IDE. The present embodiment is described with reference to the Eclipse platform IDE, however, it will be appreciated by a person of ordinary skill in the art that the invention can be applied to other IDE platforms. Each workstation further includes a local workspace, which provides a private work area for individual developers. The workspace includes a folder structure of the projects the developer is working on, which reside on a file system in the workstation 102.

An extensible IDE allows the creation of custom APIs, so that certain features or functionality can be exposed to outside developers so that they may be allowed to augment that piece of functionality themselves. For the Eclipse platform, these custom APIs are referred to as extension points, but the term extension point is used herein as a generic term.

The way Eclipse supported tagging a property to a resource is by simply allowing for an API call that sets a given property with a given value. It was left up to the developer to ensure that the key used to identify the property is unique. The developer had to “qualify” the property with a namespace that removed the risk of key collisions. Also, the keys by which these properties were retrieved were not public. Thus, a resource could not be asked to provide all the properties that it had. The user had to know the exact key to be able to call a getter to retrieve the value of the property.

In accordance with the present embodiment, an extension point was designed and implemented that allows for contributing a property to a model, and specifying whether this property is team shared or local. The XML markup specifications for this extension point is shown in FIG. 2.

The XML specification in FIG. 2 defines two elements; a property element and an extension element. The extension element comprises two attributes; a point attribute and an id attribute. The point attribute is a string, or character data (CDATA) that defines an extension point. The id attribute is string that identifies the instance of the extension point. The id attribute is optional. A content model for the extension element is the property element. Thus, the extension element may include zero or more of the property elements.

The property element comprises two attributes; a key attribute and an is TeamShared attribute. The key attribute is a string that defines the name of a property. The is TeamShared attribute is a Boolean that defines whether or not the key attribute is to be shared by a team. The default value for the is TeamShared attribute is true. If the is TeamShared attribute is false, standard persistence is used. If the is TeamShared attribute is true, persistence in accordance with the present embodiment is used. The persistence is described in detail further on in the specification.

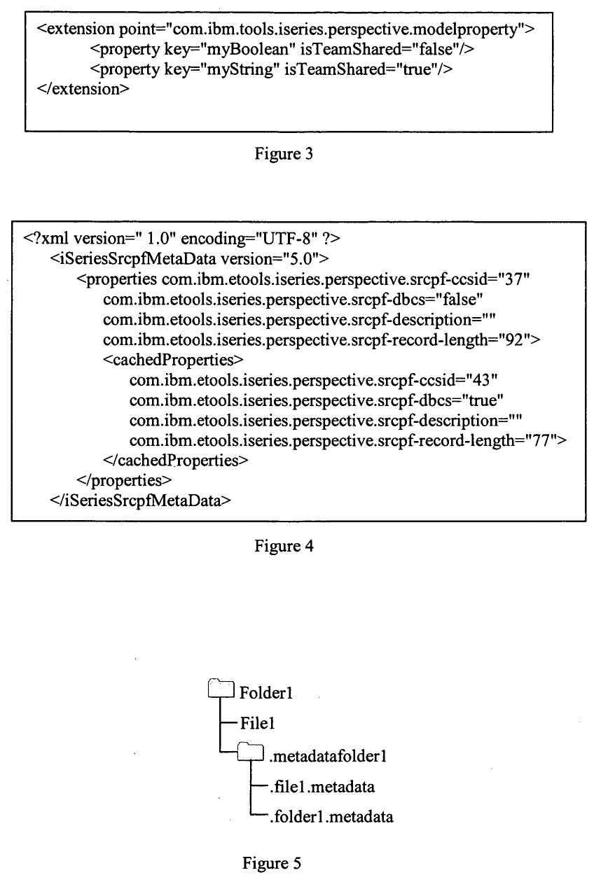

Referring to FIG. 3, a sample extension point for the model is shown. In the present example, the model automatically appends the name of each key to the name of the contributing plug-in in order to make it unique and minimize collisions with other plug-ins. For example, assuming the name of the contributing plug-in for the above properties is named “sample1”, the names for the property keys become sample1.myBoolean and sample1.myString. Thus, although the key attributes in the property element are myBoolean and myString, the model recognizes these properties as:
com.ibm.etools.iseries.perspective.isv.sample1.myBoolean; and
com.ibm.etools.iseries.perspective.isv.sample1.myString.

The implementation of this extension point fully qualifies the keys with the identification of the plug-in contributing them. Thus, even if property keys having the same local names are used, if they are used in plug-ins having different names, then their complete names will differ. This offloads some of the requirement of the user having to worry about uniquely identifying their local property keys and reduces property key collisions. If, however, the name of the key is omitted or has previously been used, the whole property element is ignored.

In accordance with the present embodiment, resource properties are persisted in a property file. The property file includes the key names and their corresponding properties. The property file is registered under the same source management tool that controls the resources themselves. Although the format used for the property file can be selected from a number of known or proprietary formats, Extensible Markup Language (XML) is used in the present embodiment. Accordingly, a resource can be probed to identify its properties. In such a case, the resource simply accesses and parses its property file and returns the key names and their associated property values, without requiring the user to have prior knowledge of the name of a required key.

Referring to FIG. 4, a sample XML property file is shown. A first element iSeriesSrcpJMetaData in the property file identifies the file as a property file with an attribute version set to 5.0. In the present embodiment, the attribute version is used for identifying the format in which the metadata is stored. A second element properties in the property file lists the names of the all keys defined for the resource and their associated properties. In this example, the property file stores the values of four properties associated with a folder resource. The keys for this resource are srcpf-ccsid, srcpf-dbcs, srcpf-description, and srcpf-record-length, which are associated with properties “37”, “false”, “ ”, and “92”, respectively.

A third element cachedProperties is used for storing previous property values for the stored keys. This enables the user, as well as other members of the team, to view previous property values as desired. In this example, the cached properties for the keys srcpf-ccsid, srcpf-dbcs, srcpf-description, and srcpf-record-length, are “43”, “true”, “ ”, and “77”, respectively.

The user of the APIs simply calls getters and setters to deal with these properties and does not need to worry about persistence. The persistence is managed by the system and is transparent to the user. In the Eclipse specific implementation, if the key is contributed as a local key, that is it is not team shared, then regular Eclipse persistence is used to store the property associated with the key. If the key is contributed as a team shared key, then both the key name and the property associated with it are stored in a metadata file similar to that illustrated in FIG. 4.

Referring to FIG. 5, a sample file structure is shown. In the present embodiment, properties of a folder are stored in a special metadata folder directly under the folder itself. Properties of all files under a given folder are stored in the metadata folder of their parent folder, with each file having its own separate metadata file.

Thus it can be seen that improved team sharing be achieved by serializing the property keys and their values in a metadata file. When a project is deleted from CVS and re-added to the workspace, all properties of all resources under a given project are loaded from the metadata files, and tooling that expects these properties to be there will not fail because of a round-trip to a repository.

It is important to note that Eclipse is only used as an implementation vehicle. However, as will be appreciated by a person of ordinary skill in the art, this invention can be applied to any extensible IDE that is file based and resource centric.

The above described invention may also be embodied in alternate forms. In an alternative aspect, there is provided a computer program product having a computer-readable medium tangibly embodying computer executable instructions for directing a IDE system to implement the method described above. It will be appreciated that the computer program product may be a floppy disk, hard disk or other medium for long term storage of the computer executable instructions.

In yet an alternative aspect, there is provided an article having a computer-readable signal-bearing medium, and having means in the medium for directing an IDE to implement the method as previously described above. It will be appreciated that a supplier of the compiler may upload the article to a network (such as the Internet) and users may download the article via the network to their respective data processing systems.

It will be appreciated that variations of some elements are possible to adapt the invention for specific conditions or functions. The concepts of the present invention can be further extended to a variety of other applications that are clearly within the scope of this invention. Having thus described the present invention with respect to a preferred embodiment as implemented, it will be apparent to those skilled in the art that many modifications and enhancements are possible to the present invention without departing from the basic concepts as described in the preferred embodiment of the present invention. Therefore, what is intended to be protected by way of letters patent should be limited only by the scope of the following claims.

1. In a team sharing environment, an integrated development environment for persisting resource properties during transitions of data between a user and a team repository, the integrated development environment comprising:
a property file for storing property keys and their associated resource property values.

2. The environment of claim 1, wherein an associated property file is created for each resource having properties to be persisted.

3. The environment of claim 1, wherein the property file is further used for storing a cache of prior resource property values.

4. The environment of claim 1, wherein the property file is searchable for returning a list of the property keys and their associated resource property values.

5. The environment of claim 1, wherein the property key name is qualified by appending the property key name to the name of the contributing resource.

6. The environment of claim 1, wherein the property file is a metadata file.

7. The environment of claim 6, wherein the metadata file is an XML file.

8. The environment of claim 1, said environment further comprising an extension point for providing an application program interface to third party plug-ins for creating a property file for the third party plug-in.

9. For a team sharing environment, a method for persisting resource properties in an integrated development environment during transitions of data between a user and a team repository, the method comprising the step of:
storing, in a property file, a list of property keys to be persisted and their associated resource property values.

10. The method of claim 9, said method further comprising the step of:
storing the property keys and values in different property files for different resources.

11. The method of claim 9, said method further comprising the step of:
storing in the property file a cache of prior resource property values.

12. The method of claim 9, said method further comprising the step of:
searching the property file for returning a list of the property keys and their associated resource property values.

13. The method of claim 9, said method further comprising the step of:
qualifying a property key name by appending the property key name to a contributing resource's name.

14. The method of claim 9, said method further comprising the step of:
providing an extension point as an application program interface to third party plug-ins for creating a property file for the third party plug-in.

15. A computer program product having a computer readable medium tangibly embodying computer executable code for directing an integrated development environment to persist resource properties in a team sharing environment during transitions of data between a user and a team repository, the computer program product comprising:
code for storing, in a property file, a list of property keys to be persisted and their associated resource property values.

16. The computer program product of claim 15, further comprising:
code for storing the property keys and values in different property files for different resources.

17. The computer program product of claim 15, further comprising:
code for storing in the property file a cache of prior resource property values.

18. The computer program product of claim 15, further comprising:
code for searching the property file for returning a list of the property keys and their associated resource property values.

19. The computer program product of claim 15, further comprising:
code for qualifying a property key name by appending the property key name to the contributing resource's name.

20. The computer program product of claim 15, further comprising:
code for providing an extension point as an application program interface to third party plug-ins for creating a property file for the third party plug-in.
